(19) United States
(12) Patent Application Publication
(10) Pub. No.: US 2011/0108700 A1
(43) Pub. Date: May 12, 2011

(54) DUCT SUPPORT ASSEMBLIES

(76) Inventor: Russell Wheeler, Hampshire (GB)

(21) Appl. No.: 13/054,462

(22) PCT Filed: Jul. 13, 2009
(86) PCT No.: PCT/GB2009/001741

§ 371 Date: Jan. 14, 2011

(30) Foreign Application Priority Data
Jul. 17, 2008 (GB) 0813055.1

(51) Int. Cl. F16L 3/18; F16L 3/16; F16F 7/00

(52) U.S. Cl. 248/636; 248/70

(57) ABSTRACT

A duct support assembly (1) is provided for mounting and supporting a duct (4) on a structure, and comprises a single support bracket (3) adapted to be mounted on the structure, and a duct bracket (5) adapted to be secured to the duct (4). The support bracket (3) and the duct bracket (5) comprise respective mounting means that engage in use to mount and support the duct bracket (5) on the support bracket (3) so as to positively locate the duct bracket (5) on the support bracket (3) in a predetermined fixed position and orientation. The duct support assembly (1) further comprises mounting adjustment means provided to enable the duct (4) and duct bracket (5) to be mounted in a plurality of positions on the support bracket (3), the mounting adjustment means enabling the duct bracket (5) to be mounted in positions towards or away from the support bracket (3).

The present invention relates to duct support assemblies and particularly but not exclusively relates to duct support assemblies for use in supporting interior or exterior ventilation ducting on a structure such as a building.

A number of duct support assemblies have been previously proposed.

One such assembly involves mounting two parallel rails vertically on, for example, a wall of a building, in laterally spaced apart relationship. Two brackets are then secured to the rails so as to be vertically spaced apart. The brackets are ‘U’ shaped when viewed in plan and are each fabricated from a number of lengths of steel to match the dimensions of the duct in question. The duct to be mounted is received within the arms of each ‘U’. Two mounting straps are provided on the duct and the ends of each strap are bolted to a respective ‘U’ shaped bracket. In an alternative embodiment four ‘L’ shaped brackets are provided, each pair of brackets being secured vertically spaced apart on the rails. Each pair of brackets is then secured to a respective mounting strap.

Another such assembly comprises four brackets, typically of ‘L’ shaped cross section lengths of metal, each being mounted directly on the wall. The brackets are ‘L’ shaped when viewed from the side and again are each fabricated from a number of lengths of steel to match the dimensions of the duct in question. Horizontal flange plates are secured to the duct, for example by welding, and each flange plate rests on, and is secured to, a respective bracket.

In each case, the brackets comprise bespoke steel fabrications, that are particular to the type and size of duct concerned. They each involve separate and precise measurement of the parts of the assembly that are secured to the building, ie the rails or brackets, to ensure that for example, the rails are vertical and correctly spaced apart, the spacing varying from duct to duct. Each of the components also requires separate mounting on the next, in situ on site, such that there are a relatively high number of components and steps required to successfully mount the duct on the building. Additionally, the exact interlocation of components is imprecise and unguided such that it can be difficult to correctly align and mount all of the components.

Prior assemblies therefore typically require relatively expensive and time consuming fabrication of components to fit the particular duct in question, a relatively high number of parts requiring imprecise and time consuming individual mounting, time consuming and fiddly interlocation of components, and also. typically have a cluttered and unsightly appearance.

According to a first aspect of the invention there is provided a duct support assembly for mounting and supporting a duct on a structure, the assembly comprising a single support bracket adapted to be mounted on the structure, and a duct bracket adapted to be secured to the duct, the support bracket and the duct bracket comprising respective mounting means that engage in use to mount and support the duct bracket on the support bracket so as to positively locate the duct bracket on the support bracket in a predetermined fixed position and orientation, the duct support assembly further comprising mounting adjustment means provided to enable the duct and duct bracket to be mounted in a plurality of positions on the support bracket, the mounting adjustment means enabling the duct bracket to be mounted in positions towards or away from the support bracket to vary the spacing between the brackets.

Preferably the mounting means are such that the duct bracket is supported on the support bracket at longitudinally spaced apart positions, that is, positions spaced apart in a direction parallel with the longitudinal axis of the duct.

Air extraction ducting and extractor fans are also becoming more widely used in car parks, particularly when the car park is underground. Such ducting and fans are also often used in relatively high quantities in vehicle tunnels and the like.

Preferably the mounting means are such that the duct bracket is supported on the support bracket at laterally spaced apart positions, that is, positions spaced apart in a direction perpendicular with the longitudinal axis of the duct.

Preferably the mounting means of at least one of the support bracket and duct bracket comprises a channel dimensioned to receive a mounting protrusion comprising the mounting means of the other of the support bracket and duct bracket.

Preferably the channel is provided on the support bracket, the protrusion being provided on the duct bracket.

Preferably the channel and/or protrusion are formed integrally with the respective bracket.

Preferably the assembly comprises a single support bracket and a single duct bracket.

Preferably one bracket comprises a planar back plate and two planar side plates extending perpendicularly from respective side margins thereof, the back and side plates being arranged to define the channel therebetween.

Preferably one bracket comprises at least one planar front plate and two planar side plates extending perpendicularly from respective side margins thereof, the front and side plates being arranged to define the protrusion.

Preferably the bracket comprises two planar front plates, the planar side plates extending from side margins of respective front plates.

Preferably the duct bracket comprises a pair of mounting flanges laterally spaced from the protrusion, the flanges being adapted to be secured to the duct.

Preferably the mounting flanges are movable relative to the duct bracket so that the mounting flanges can be mounted with the planes of each flange substantially flush with the outer surface of ducts of differing sizes.

Preferably a third mounting flange is provided intermediate the pair of mounting flanges.

Preferably the mounting adjustment means comprises a roller on one bracket, and a track on the other bracket, the roller in use being rollable along the track to vary the spacing between the brackets.

The mounting adjustment means may comprise a support channel on one bracket, and a rib on the other bracket, the rib being received in use in the channel to vary the spacing between the brackets.

Preferably the mounting adjustment means comprises a plurality of mounting apertures on one bracket, and at least one mounting aperture on the other bracket, the brackets being movable such that different mounting apertures on one bracket can be aligned with the mounting aperture on the other bracket to vary the spacing between the brackets.

Preferably an anti-vibration mount is provided between the duct and the support bracket.

Preferably the anti-vibration mount is provided between the duct bracket and the support bracket.

Preferably the anti-vibration mount is provided by way of an anti-vibration bracket mounted between the duct bracket and the support bracket.

Other aspects of the present invention may include any combination of the features or limitations referred to herein.

The present invention may be carried into practice in various ways, but embodiments will now be described by way of example only with reference to the accompanying drawings in which:

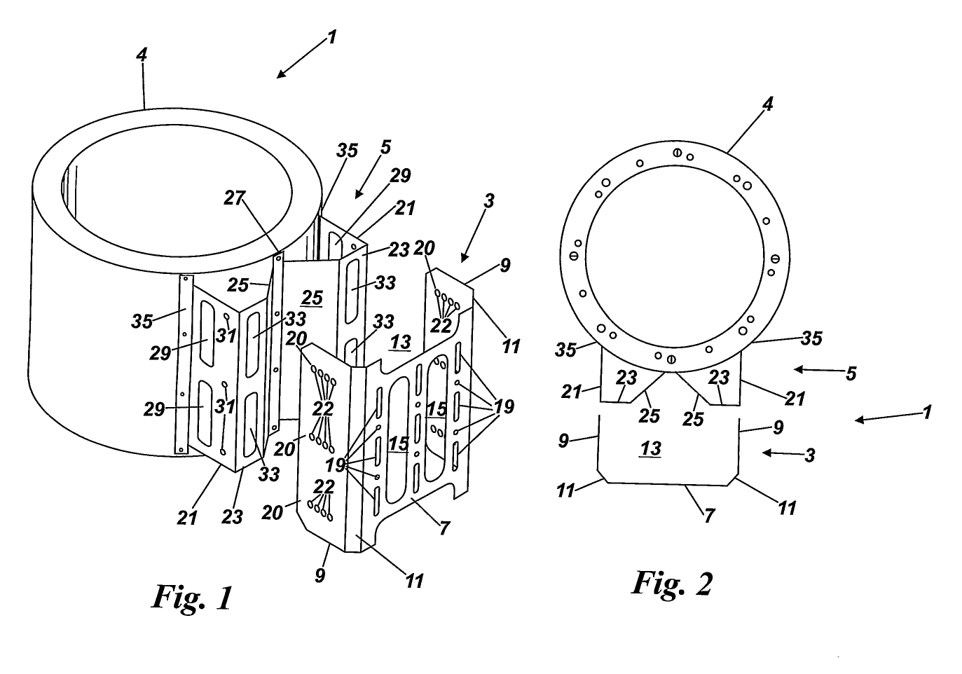

FIG. 1 is an exploded perspective view of a duct support assembly in accordance with the present invention, secured to a duct comprising a silencer;

FIG. 2 is an exploded plan view of the duct support assembly of FIG. 1;

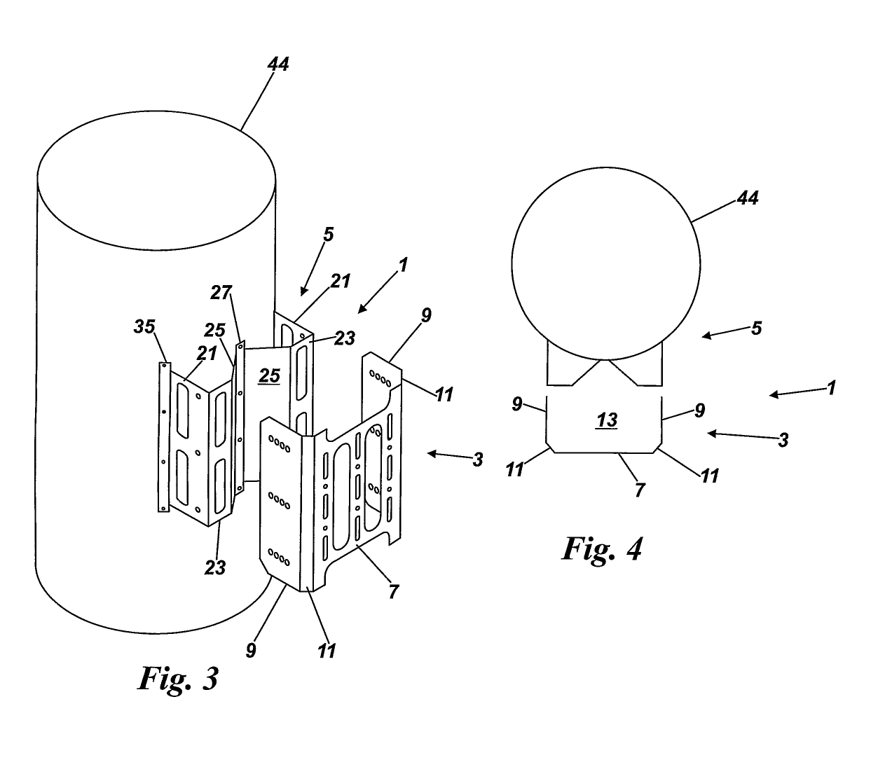

FIG. 3 is an exploded perspective view of another duct support assembly in accordance with the present invention, secured to a duct;

FIG. 4 is an exploded plan view of the duct support assembly of FIG. 3;

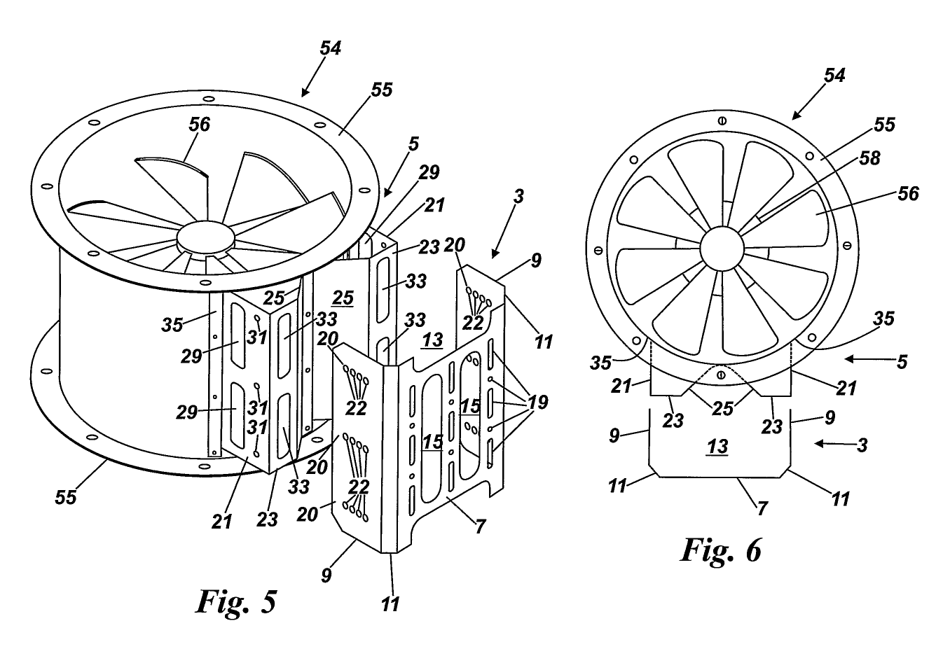

FIG. 5 is an exploded perspective view of a further duct support assembly in accordance with the present invention, secured to a fan housing duct;

FIG. 6 is an exploded plan view of the duct support assembly of FIG. 5;

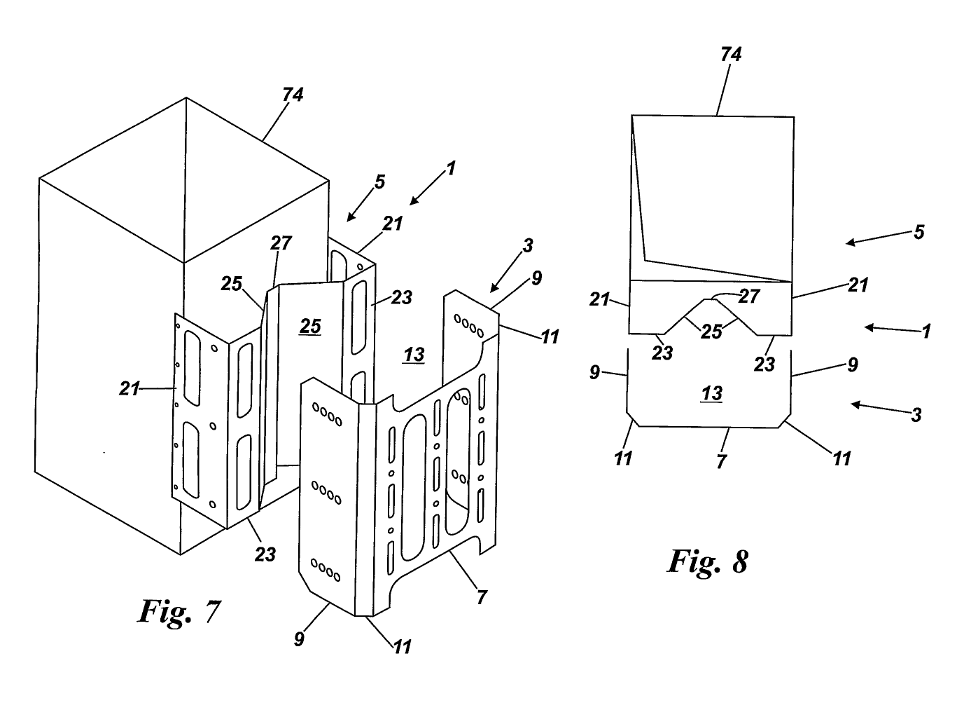

FIG. 7 is an exploded perspective view of a yet further duct support assembly in accordance with the present invention, secured to a square section duct;

FIG. 8 is an exploded plan view of the duct support assembly of FIG. 7;

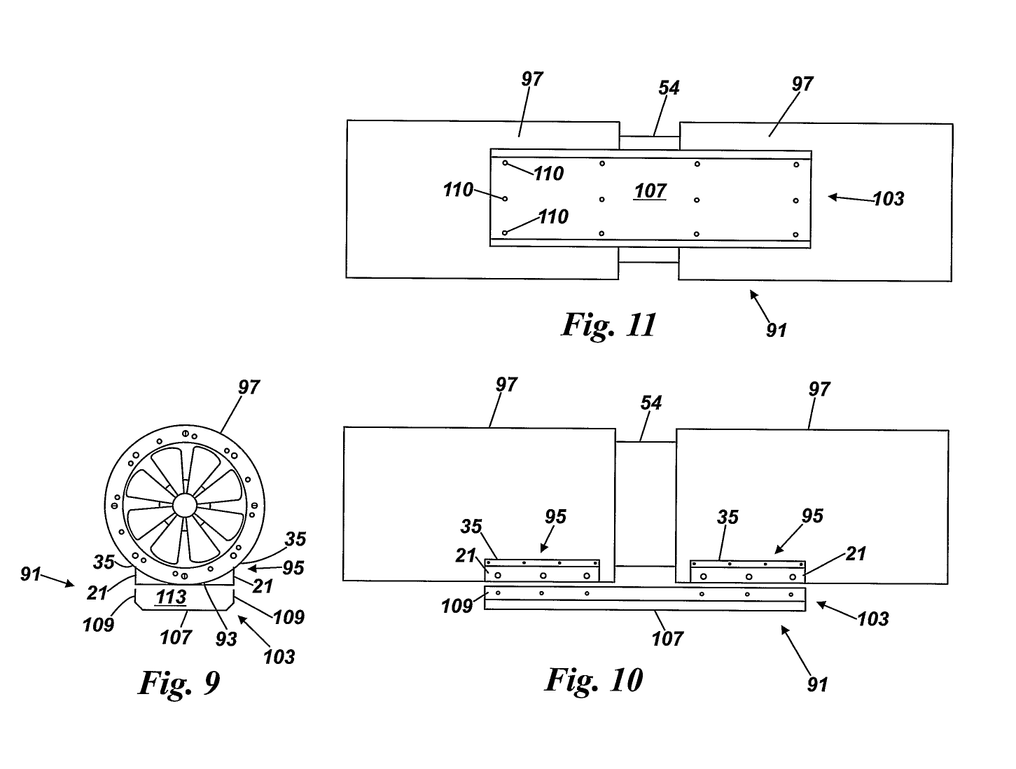

FIG. 9 is an exploded end view of a floor mounted duct support assembly in accordance with the present invention, secured to two ducts, between which is a fan housing duct;

FIG. 10 is a side view of the assembly of FIG. 9;

FIG. 11 is a plan view of the assembly of FIGS. 9 and 10.

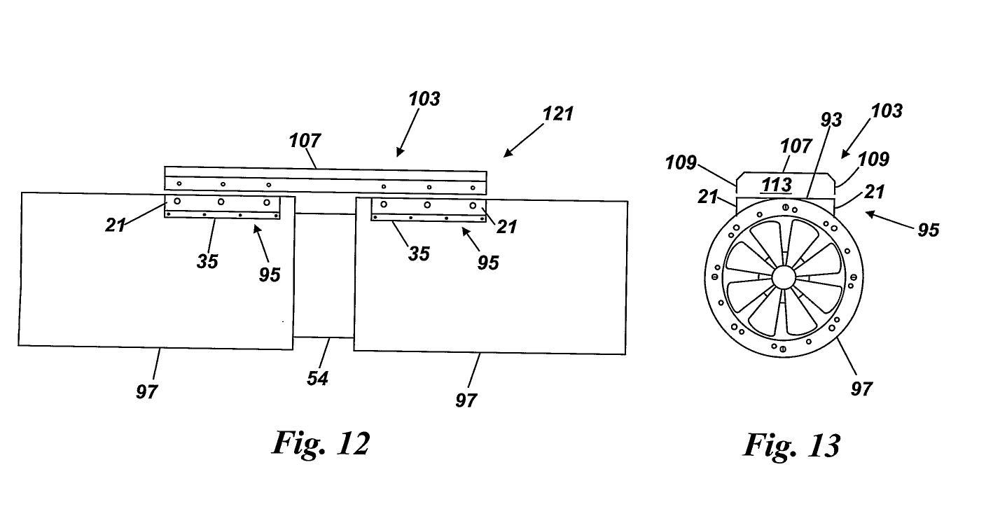

FIG. 12 is a side view of an underslung ceiling mounted duct support assembly in accordance with the present invention;

FIG. 13 is an exploded end view of the assembly of FIG. 12;

FIG. 14 is an exploded plan view of another duct support assembly in accordance with the present invention;

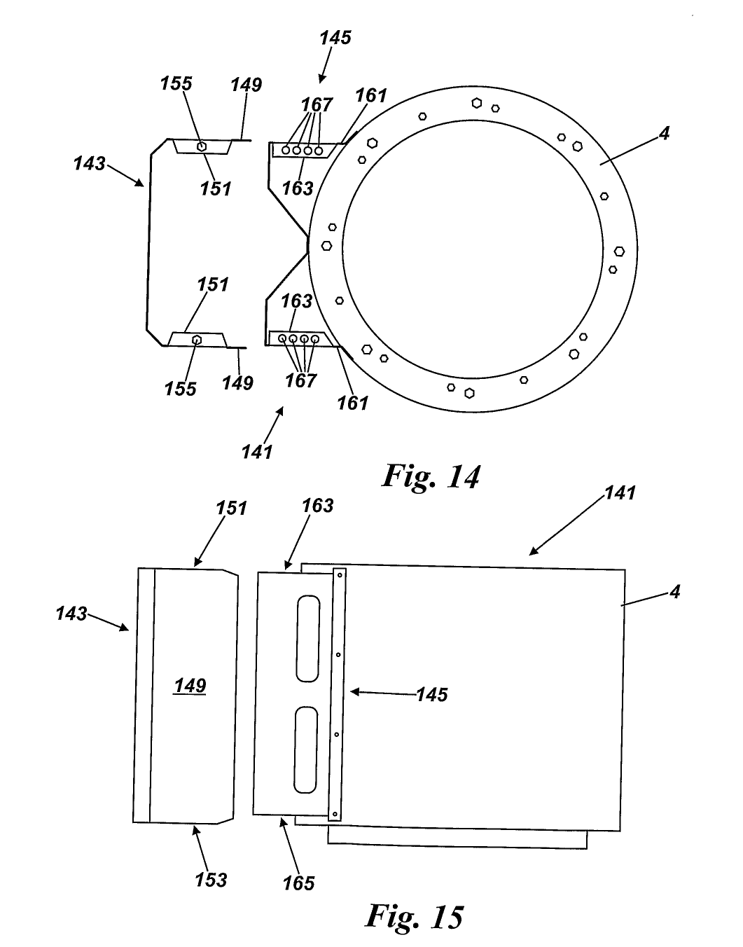

FIG. 15 is an exploded side view of the assembly of FIG. 14;

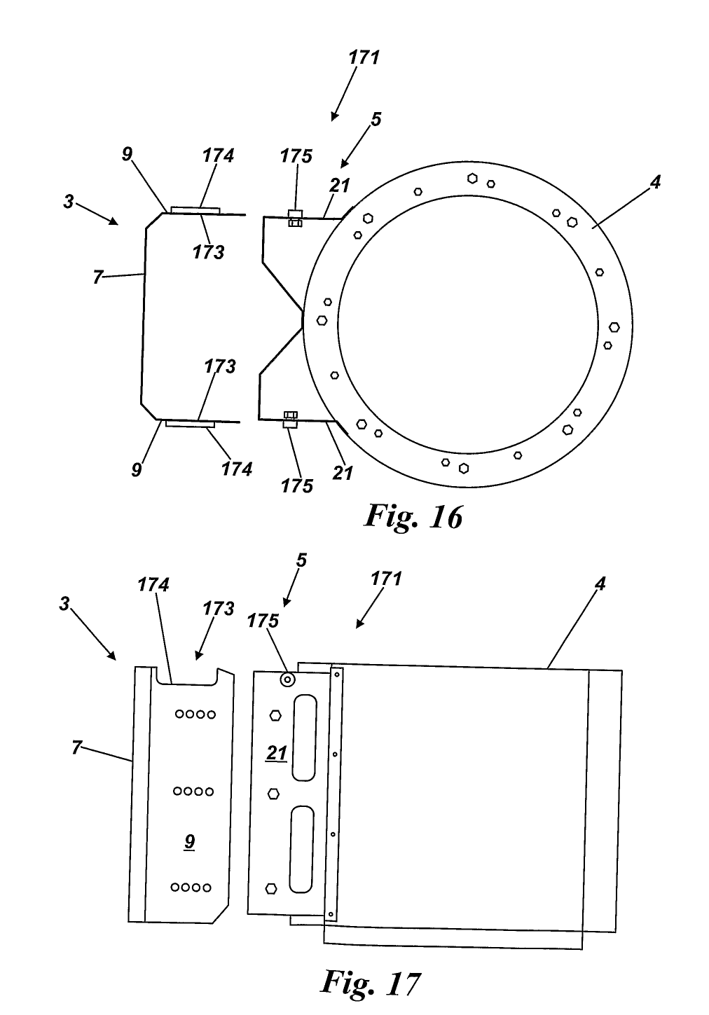

FIG. 16 is an exploded plan view of a further duct support assembly in accordance with the present invention;

FIG. 17 is an exploded side view of the assembly of FIG. 17;

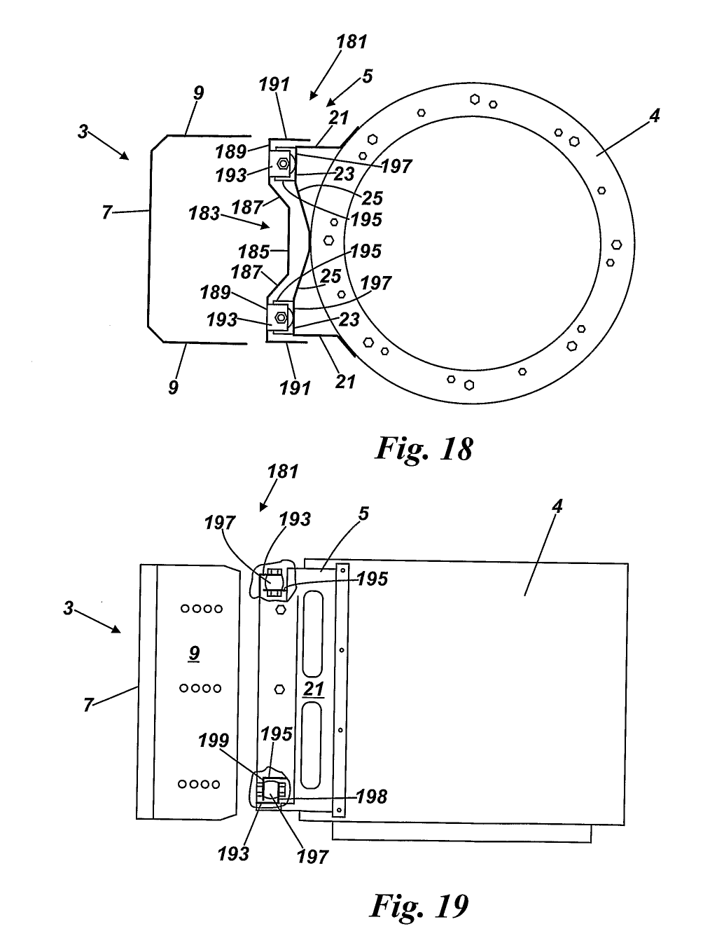

FIG. 18 is an exploded plan view of a yet further duct support assembly in accordance with the present invention; and

FIG. 19 is an exploded side view of the assembly of FIG. 18 with part of the assembly cut away for clarity.

Referring initially to FIGS. 1 and 2, a duct support assembly 1 comprises two components: a support bracket 3 adapted to be mounted to a structure such as a building, and a duct bracket 5 adapted to be both secured to a duct 4 and mounted and supported on the support bracket 3.

The support bracket 3 is formed from a single plate sheet of metal such as steel or aluminium or the like, bent to form a planar back plate 7 and two spaced apart parallel planar side plates 9 joined to the side margins of the back plate 7 by respective angled plate strips 11. The back plate 7 and two side plates 9 together define an oblong cross section channel 13 that functions as mounting means.

The back plate 7 is formed with two parallel elongate slots 15 and a plurality of smaller mounting apertures in the form of smaller slots 17 and circular apertures 19. The slots 17 and apertures 19 are used to mount the support bracket on the wall, floor or ceiling of the building, for example using screws and rawlplugs received in bores drilled in the building. The slots 17 and apertures 19 may of course be used as a drilling guide if the support bracket 3 is held in position against the building during or prior to drilling.

The side plates 9 are each formed with mounting adjustment means comprising, in this example, three vertically spaced horizontal rows 20 of four apertures 22.

The duct bracket 5 is also formed from a single sheet of plate metal bent to form two parallel spaced apart, planar side plates 21 each leading to a respective planar front plate 23, the two front plates 23 being at 90° to the side plates 21 and being laterally spaced apart in the same plane. The other side margin of each front plate 23 leads to a respective planar angled plate 25, the two angled plates 25 meeting at a central mounting flange 27.

The side plates 21 and front plates 23 together comprise mounting means defining a protrusion dimensioned to be received in the channel 13 of the support bracket 3.

The side plates 21 each comprise a plurality of mounting apertures including two large slots 29 and three circular apertures 31. The front plates 23 each comprise two large slots 33.

The duct bracket 5 is adapted to be mounted on any size or shape of duct 4 by virtue of two elongate mounting flanges 35, and the central mounting flange 27. Each mounting flange 35 extends down a respective side margin of the side plates 21. The orientation of the plane of each mounting flange 35 relative to the plane of the respective side plate 21 can be altered so as to be flush with the outside of the duct 4 in question. The mounting flanges 35, and the central mounting flange 27, are secured to the outside of the duct 4 using any suitable means which in this example comprise rivets. It is envisaged that the duct bracket 5 would be secured to the duct 4 during manufacture of the duct 4 rather than on site.

On site, the support bracket 3 is positioned on the part of the structure in question, and this may for example be a floor, ceiling or wall of a building. A spirit level may be used to correctly orientate the support bracket 3 but no other measurement should be required. Drill holes are marked using an appropriate combination of the slots 17 and circular apertures 19 as a template. Bores are then drilled using the marks and suitable wall fixings, such as rawl plugs, inserted into each bore as required. The support bracket 3 is then repositioned with the appropriate slots 17 and circular apertures 19 aligned with the drilled holes, into which suitable screws are inserted.

The duct 4 and duct bracket 5 are then mounted on the support bracket 3 by positioning the duct bracket 5 within the channel 13 defined by the back and side plates 7, 9 of the support bracket 3. In particular the side plates 9 of the duct bracket 5 are slid against respective side plates 9 of the support bracket 3 such that the side plates 9, 21 are parallel and adjacent, and such that the three circular mounting apertures 31 on the duct bracket 5 side plates 21 are aligned with a respective one of the four apertures 22 in each row 20 of apertures on the support bracket side plates 9. The spacing of the duct 4 from the building can thus be varied by aligning the mounting apertures 31 with different apertures 22 in each row 20 on the support bracket 3, the side plates 9, 21 maintaining the orientation of the duct bracket 5 relative to the support bracket 3 all the while. Suitable fixings, such as nuts and bolts, are used to secure the duct bracket 5 to the support bracket 3.

The above assembly 1 is thus considerably simpler and quicker than existing assemblies to manufacture and install, and alleviates any requirement for fabrication and components bespoke to the particular duct in question. Considerable cost savings are therefore achieved from the combination of the installation time saving, and the mass production techniques now possible for the support and duct brackets 3, 5, these being of a single standard size for use with ducts of varying sizes, shapes and features.

Furthermore, the difficulties experienced with prior assemblies in measurement and orientation of the various components in order to ensure that they align and fit together are alleviated, not least because the number of components has been reduced. The position and orientation of the duct bracket 5 relative to the duct 4 is fixed on manufacture. The position and orientation of the support bracket 3 is simply achieved with a single use of a spirit level. The position and orientation of the duct bracket 5 (and duct 4) relative to the support bracket 3 (and building) is determined and fixed by the engagement of the side plates 9, 21 of the two brackets 3, 5 that positively locate the duct bracket 5 on the support bracket 3 in a predetermined fixed position and orientation such that no additional measurement or adjustment of the orientation of either bracket 3, 5 is required.

It is envisaged that the above described assembly 1 could be assembled in about five minutes as compared to over an hour for existing assemblies.

Referring to FIGS. 3 and 4, the above described duct assembly 1 is shown in use with a smaller diameter, longer length duct 44. It will be noted that the planes of the mounting flanges 35 have been adjusted so as to be flush with the exterior surface of the smaller diameter duct 44.

Referring to FIGS. 5 and 6, the above described duct assembly 1 is shown in use with a smaller diameter fan housing duct 54 formed with upper and lower, radially outwardly extending connector flanges 55. The duct bracket 5 is secured to the fan housing duct 54 intermediate the two connector flanges 55. It will be noted that the planes of the mounting flanges 35 have been adjusted so as to be flush with the exterior surface of the fan housing duct 54. The fan housing duct 54 houses, for example, an extractor fan 56 and motor 58. The fan housing duct 54 may also house a fan controller and electrical connections as required.

Referring to FIGS. 7 and 8, the above described duct assembly 1 is shown in use with a square section duct 74. It will be noted that in this embodiment, the mounting flanges are omitted and the side plates 21 of the duct bracket 5 are secured directly to the sides 75 of the square section duct 74.

Referring to FIGS. 9 to 11, a floor mounted duct support assembly 91 is designed for use with three ducts, in this case, an intermediate fan housing duct 54 and two longitudinally spaced apart wider diameter extractor ducts 97.

In this example a modified support bracket 103 is of similar structure but is longer than the support bracket 3 described above and thus defines an elongate channel 113 between an elongate back plate 107 and elongate side plates 109. The back plate 107 is provided with a plurality of mounting apertures 110 for mounting the back plate 107 to the floor or another supporting structure.

In this example two duct brackets 95 are provided, as described above with reference to brackets 5, except only comprising one wider front plate 93 and no angled plates 25, each bracket 95 being secured to a respective wider diameter silencer portion 97 as described above.

Each duct bracket 95 is received in a respective part of the channel 113 of the support bracket 103 such that each wider diameter extractor 97 is mounted and supported on a respective end of the support bracket 103 the fan housing duct 54 being supported by and between the extractor ducts 97.

Referring to FIGS. 12 and 13, an underslung ceiling mounted duct support assembly 121 comprises identical features to the assembly 91 but is inverted such that the back plate 107 of the support bracket 103 can be mounted to the ceiling of an underground car park or tunnel or the like as part of an exhaust air extractor assembly.

Referring to FIGS. 14 and 15 another duct support assembly 141 comprises a support bracket 143, and a duct bracket 145 adapted to be both secured to a duct 144 and mounted and supported on the support bracket 143.

In this example the side plates 149 of the support bracket 3 are each formed with an upper mounting plate 151 and a lower mounting plate 153, each of which comprise a part of the side plate 149 bent at 90°. Each upper and lower mounting plate 151, 153 is formed with a respective mounting aperture 155.

Each side plate 161 of duct bracket 145 also comprises upper and lower mounting plates 163, 165 each of which comprise a part of the side plate 161 bent at 90°. Each upper and lower mounting plate 163, 165 is formed with a plurality of mounting apertures 167 arranged in a line along each plate 163, 165. The mounting apertures 167 comprise mounting adjustment means.

In this example, the duct bracket 145 is mounted on the support bracket 143 by engagement between the mounting plates 151, 153, 163, 165. As the duct bracket is slid onto the support bracket 143, the lower mounting plates 151 of the support bracket 143 support the lower mounting plates 163 of the duct bracket 145. This supports some of the weight of the duct bracket 145 and duct 144 during assembly.

The spacing of the duct bracket 145 from the back plate of the support bracket 143, ie from the wall or the like on which the support bracket 143 is mounted, can be adjusted by aligning different apertures 167 of the duct bracket 145 with the aperture 155 on the mounting plates 151, 153 of the support bracket 143.

Referring now to FIGS. 16 and 17, a further duct support assembly 171 is of similar construction to those described above with reference to FIGS. 1 and 2 except that in this example the upper margin of each side plate 9 of the support bracket 3 comprises an elongate cutout 173 that defines a bent plate forming a track 174. The side plates 21 of the duct bracket 5 are provided, at an upper position, with respective roller bearings 175. The cut-out 173 and the roller bearings 175 comprise mounting adjustment means.

In use the duct bracket 5 is positioned relative to the support bracket 3 such that the roller bearings 175 rest on respective tracks 174. The tracks 174 thus support a large part of the weight of the duct bracket 5 and duct 4. The spacing between the duct bracket 5 and the support bracket 3 can be adjusted by rolling the bearings 175 along the respective tracks 174. The final position of the duct bracket 5 on the support bracket 6 can be fixed using suitable fixings through the apertures 20 on the support bracket 3 and the apertures 31 on the duct bracket 5.

Although not shown in the Figures, the rows of apertures 20 may be formed on raised elongate ribs of the side plates 9 of the duct bracket 3, that is, ribs of the side plates 9 that are bent outwardly so that each side plate 9 is corrugated when viewed end on. Each side plate 9 is thus formed with a plurality of spaced apart guide channels formed by the underside of the ribs. The duct support 5 can be formed with corresponding outwardly projecting ribs that in use mate with the guide channels on the support bracket 3. This mating can help to support and guide the duct bracket 5 onto the support bracket 3 in use. The ribs comprise mounting adjustment means.

Referring now to FIGS. 18 and 19, a further duct support assembly 181 is of similar construction to that described above with reference to FIGS. 1 and 2 except that in this example, an anti-vibration bracket 183 is mounted intermediate the support bracket 3 and the duct bracket 5.

The anti-vibration bracket 183 is of bent sheet metal construction and comprises a central plate 185, the side margins of which lead to angled link plates 187. A respective back plate 189 is provided at the side margin of each link plate 187. A respective side plate 191 is provided at 90° to each back plate 189.

The top and bottom margin of each back plate 189 is provided with a mounting tab 193 bent at 90° to the plane of the respective back plate 189. Likewise, the front plates 23 of the duct support 5 are provided with mounting tabs 195 bent at 90° to the plane of the respective back plates 189. The anti-vibration bracket 183 can thus be positioned adjacent the duct bracket 5 with the mounting tabs 193 vertically spaced from the mounting tabs 195 of the duct bracket 5. Anti-vibration elements 197 are positioned between adjacent tabs 193, 195 and form an anti-vibration mounting of the anti-vibration bracket 183 on the duct bracket 5. The anti-vibration elements 197 can comprise any suitable material and construction including, for example, rubber elements, or springs.

The lower tabs 193, 195 may comprise additional 90° bent tabs 198, 199 between which the anti-vibration elements 197 are mounted. Thus the upper anti-vibration elements 197 can be arranged to absorb generally vertical vibration whilst the lower anti-vibration elements 197 are arranged to absorb generally horizontal vibration.

In use, the anti-vibration bracket 183, with the attached duct bracket 5, is received in the channel 13 of the support bracket 3 and secured thereto using suitable fixings through the side plates of the anti-vibration bracket 183 and the side plates 9 of the support bracket 3.

The brackets 3, 5, 95, 103, 143, 145, 183 described above could be made from any suitable material including, for example a metal or metal alloy, or any other non-metallic material or combination of materials. The exact dimensions of the brackets 3, 5, 95, 103, 143, 145, 183 can be selected as required. However, as a non limiting example only, for external ducting such as commercial kitchen extractor fan ducting, a bracket width of about 300 mm could be appropriate for a duct diameter or width of about 500 mm. The exact dimensions will depend on the material and number of brackets 3, 5, 95, 103, 143, 145, 183 used and can be varied as required.

The brackets 3, 5, 95, 103, 143, 145, 183 are envisaged primarily for use with interior/exterior ducting on commercial buildings or underground car parks but modified brackets 3, 5, 95, 103, 143, 145, 183 could alternatively or additionally be used with any other type of ducting, for example, ducting in domestic kitchen extractor fans, or ducting on ships.

It is envisaged that any of the features of one of the examples described above could be combined with any of the brackets 3, 5, 95, 103, 143, 145, 183. For example, the roller bearings 175 could be combined with the duct support assembly 181 of FIGS. 18 and 19, or the anti-vibration bracket 183 could be combined with the duct support assembly 91 of FIGS. 9 to 11.

1. A duct support assembly for mounting and supporting a duct on a structure, the assembly comprising a single support bracket adapted to be mounted on the structure, and a duct bracket adapted to be secured to the duct, the support bracket and the duct bracket comprising respective mounting means that engage in use to mount and support the duct bracket on the support bracket so as to positively locate the duct bracket on the support bracket in a predetermined fixed position and orientation and further comprising mounting adjustment means to enable the duct and duct bracket to be mounted in a plurality of positions on the support bracket, the mounting adjustment means enabling the duct bracket to be mounted in positions towards or away from the support bracket to vary the spacing between the brackets

2. The duct support assembly of claim 1 wherein the mounting means are such that the duct bracket is supported on the support bracket at longitudinally spaced apart positions, that is, positions spaced apart in a direction parallel with the longitudinal axis of the duct.

3. The duct support assembly of claim 2 wherein the mounting means are such that the duct bracket is supported on the support bracket at laterally spaced apart positions, that is, positions spaced apart in a direction parallel with the longitudinal axis of the duct.

4. The duct support assembly of claim 1 wherein the mounting means of at least one of the support bracket and duct bracket comprises a channel dimensioned to receive a mounting protrusion comprising the mounting means of the other of the support bracket and duct bracket.

5. The duct support assembly of claim 4 wherein the channel is provided on the support bracket, the protrusion being provided on the duct bracket.

6. The duct support assembly of claim 4 wherein the channel and/or protrusion are formed integrally with the respective bracket.

7. The duct support assembly of claim 1 wherein the assembly comprises a single support bracket and a single duct bracket.

8. The duct support assembly of claim 4 wherein one bracket comprises a planar back plate and two planar side plates extending perpendicularly from respective side margins thereof, the back and side plates being arranged to define the channel therebetween.

9. The duct support assembly of claim 4 wherein one bracket comprises at least one planar front plate and two planar side plates extending perpendicularly from respective side margins thereof, the front and side plates being arranged to define the protrusion.

10. The duct support assembly of claim 9 wherein the bracket comprises two planar front plates, the planar side plates extending from side margins of respective front plates.

11. The duct support assembly of claim 4 any wherein the duct bracket comprises a pair of mounting flanges laterally spaced from the protrusion, the flanges being adapted to be secured to the duct.

12. The duct support assembly of claim 11 wherein the mounting flanges are movable relative to the duct bracket so that the mounting flanges can be mounted with the planes of each flange substantially flush with the outer surface of ducts of differing sizes.

13. The duct support assembly of claim 11 wherein a third mounting flange is provided intermediate the pair of mounting flanges.

14. The duct support assembly of claim 1 wherein the mounting adjustment means comprises a roller on one bracket, and a track on the other bracket, the roller in use being rollable along the track to vary the spacing between the brackets.

15. The duct support assembly of claim 1 wherein the mounting adjustment means comprises a support channel on one bracket, and a rib on the other bracket, the rib being received in use in the channel to vary the spacing between the brackets.

16. The duct support assembly of claim 1 wherein the mounting adjustment means comprises a plurality of mounting apertures on one bracket, and at least one mounting aperture on the other bracket, the brackets being movable such that different mounting apertures on one bracket can be aligned with the mounting aperture on the other bracket to vary the spacing between the brackets.

17. The duct support assembly of claim 1 wherein comprising an anti-vibration mount between the duct and the support bracket.

18. The duct support assembly of claim 17 wherein the anti-vibration mount is provided between the duct bracket and the support bracket.

19. The duct support assembly of claim 18 wherein the anti-vibration mount is provided by way of an anti-vibration bracket mounted between the duct bracket and the support bracket.

20. The duct support assembly of claim 17 comprising upper and lower anti-vibration elements wherein the upper anti-vibration element is arranged to absorb generally vertical vibration whilst the lower anti-vibration element is arranged to absorb generally horizontal vibration.
